(19) United States
(12) Patent Application Publication
(10) Pub. No.: US 2015/0354263 A1
(43) Pub. Date: Dec. 10, 2015

(54) Thermal Break Glazing Insulation and Infiltration Reduction System

(71) Applicant: Dennis Gary Roberts, San Antonio, TX (US)

(72) Inventor: Dennis Gary Roberts, San Antonio, TX (US)

(21) Appl. No.: 14/734,361

(22) Filed: Jun. 9, 2015

Related U.S. Application Data
(60) Provisional application No. 62/010,075, filed on Jun. 10, 2014.

(51) Int. Cl. E06B 3/64; E06B 3/56; E06B 3/67; E06B 3/02

(52) U.S. Cl. CPC E06B 3/64; E06B 3/025; E06B 3/56; E06B 3/67

(57) ABSTRACT

A thermal break glazing insulation and infiltration reduction system is a system for minimizing heat loss and heat gain through an existing window. A second glazing panel is installed into an existing window unit with a first glazing panel that is installed into a window frame. The second glazing unit does not come into contact with the window frame or the first glazing panel. Additionally, the second glazing unit is offset from the first glazing unit in order to create a trapped air space through which thermal energy is unable to pass. The width of the trapped air space is determined on the basis of individual needs and may be widened through the use of an at least one L-shaped bracket. The second glazing panel is attached to the first glazing panel or the at least one L-shaped bracket via an at least one spacer.

The current application claims a priority to the U.S. Provisional Patent application Ser. No. 62/010,075 filed on Jun. 10, 2014.

### FIELD OF THE INVENTION

The present invention relates generally to a system for minimizing heat loss, heat gain, and window air infiltration. More specifically, the present invention is a thermal break glazing insulation and infiltration reduction system for minimizing heat loss and heat gain as well as reducing air infiltration through the introduction of an additional glazing unit that is spaced off and thermally separated from the existing glazing.

### BACKGROUND OF THE INVENTION

A significant amount of heat loss and heat gain in a building typically occurs through windows, glass doors, or skylights. In cold weather conditions, heat is lost from the interior of a building through window glass, particularly if the window glass is single-pane glazing. Double-pane glazing provides only minor improvement through the implementation of double glass window panes that are separated by an air space or a gas filled space. With all types of windows, the heat loss is generally noticeable in the form of temperature disparities throughout a building with the cold zones being found in the vicinity of windows. In contrast to cold weather conditions, hot weather conditions often result in uncomfortably hot conditions within the interior of a building due to the solar and radiant heating of the building interior through the glazing. Much like heat loss, heat gain is most noticeable in the form of temperature disparities throughout a building.

Air infiltration is another issue that is inherent to glazing. This uncontrollable introduction of air into a building results in not only increased energy costs, but the decline of indoor air quality. In addition to increased energy costs, infiltration can result in dust, pollen, vehicle exhaust, and other pollutants entering a building. Infiltration can also result in increased moisture within a building as well.

The present invention is a thermal break glazing insulation and infiltration reduction system that introduces an additional glazing in order to minimize heat loss and heat gain through an existing window unit as well as infiltration through the window unit. The additional glazing is offset from the glazing of the existing window unit in order to create a trapped air space in between the additional glazing and the glazing of the existing window unit.

### BRIEF DESCRIPTION OF THE DRAWINGS

FIG. 1 is a perspective view of the present invention.

FIG. 2 is a side view of the present invention.

FIG. 3 is a detail view of the present invention taken from circle A of FIG. 1.

FIG. 4 is a perspective exploded view of the present invention.

FIG. 5 is a side view of a first alternative embodiment of the present invention with a wider trapped air space.

FIG. 6 is a detail view of the first alternative embodiment of the present invention taken from circle B of FIG. 4.

FIG. 7 is a perspective exploded view of the first alternative embodiment of the present invention with a wider trapped air space.

FIG. 8 is a side view of a second alternative embodiment of the present invention with an even wider trapped air space.

FIG. 9 is a detail view of the second alternative embodiment of the present invention taken from circle C of FIG. 7.

FIG. 10 is a perspective exploded view of the second alternative embodiment of the present invention with an even wider trapped air space.

### DETAIL DESCRIPTIONS OF THE INVENTION

All illustrations of the drawings are for the purpose of describing selected versions of the present invention and are not intended to limit the scope of the present invention.

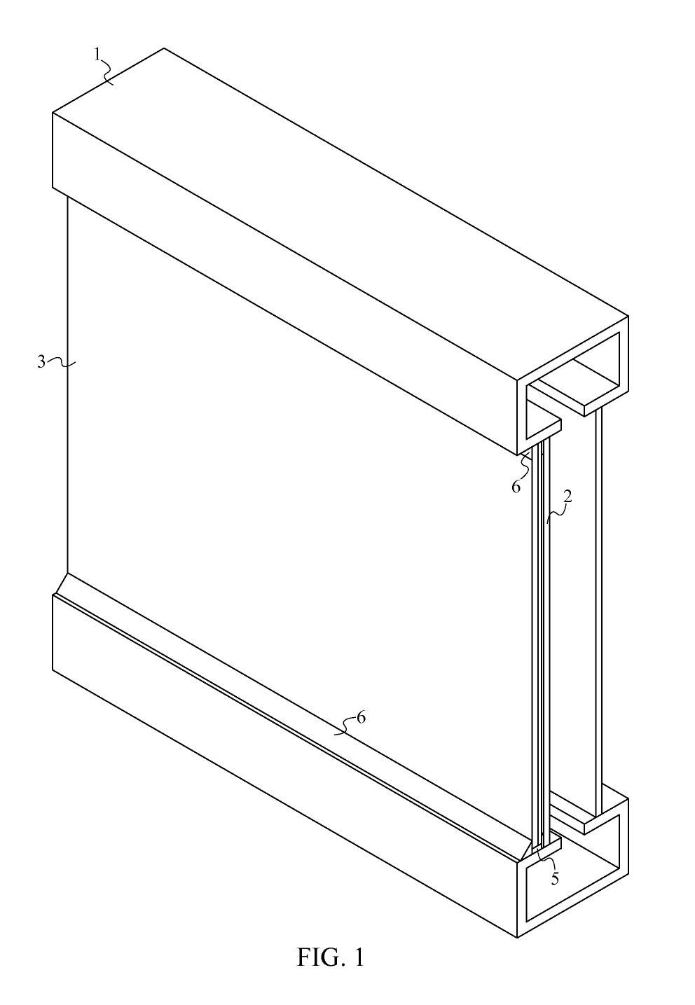

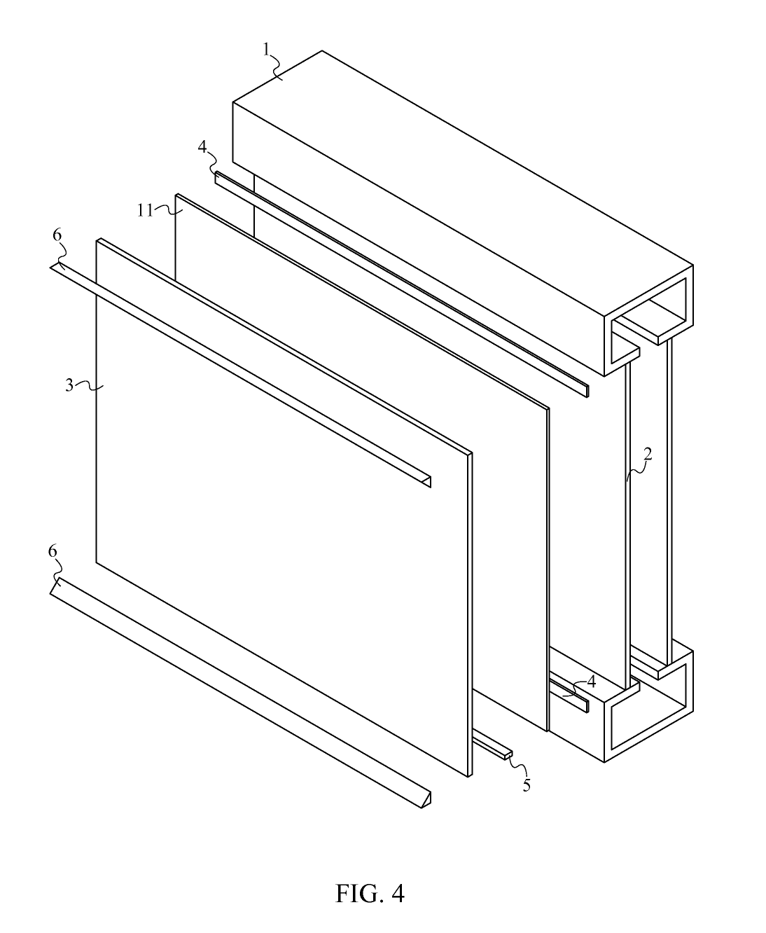

The present invention is a thermal break glazing insulation and infiltration reduction system. The present invention is shown in FIGS. 1-4 and comprises a window frame 1, a first glazing panel 2, a second glazing panel 3, an at least one spacer 4, an at least one riser 5, and an at least one backing spacer 6. The present invention is primarily intended to minimize heat loss and heat gain through an existing window unit. In the preferred embodiment of the present invention, the at least one spacer 4, the at least one riser 5, and the at least one backing spacer 6 are all composed of a non-conductive material. Additionally, the at least one spacer 4, the at least one riser 5, and the at least one backing spacer 6 are present on all sides or edges of the existing window unit.

The window frame 1 delineates the boundary of the existing window unit within the structure of a building and additionally provides structural support for the existing window unit. Within the context of the present invention, the first glazing panel 2 is an existing glazing unit composed of glass that is installed within the existing window unit. The second glazing panel 3 is an additional glazing unit that is installed into the existing window unit in order to form a trapped air space 7 in between the first glazing panel 2 and the second glazing panel 3. The trapped air space 7 serves as a thermal break and prevents thermal energy from passing through the first glazing panel 2 and the second glazing panel 3. The first glazing panel 2 may be the innermost or outermost glazing of the existing window unit. As such, the second glazing panel 3 may be installed to the interior or the exterior of the existing window unit based on individual needs. The at least one spacer 4 serves to provide separation between the second glazing panel 3 and the first glazing panel 2 in order to prevent contact between the second glazing panel 3 and the first glazing panel 2 as well as to form the trapped air space 7. The at least one riser 5 is utilized to provide separation and prevent contact between the second glazing panel 3 and the window frame 1. This prevents any conduction of heat between the first glazing panel 2 and the second glazing panel 3. The at least one backing spacer 6 serves to hold the second glazing panel 3 in place against the at least one spacer 4 when installed, creating the trapped air space 7. The at least one backing spacer 6 is able to form the trapped air space 7 by creating a seal through which moisture and air are unable to pass. This is due to the fact that the at least one spacer 4, the at least one riser 5, and the at least one backing spacer 6 are present on all sides or edges of the existing window unit.

The present invention further comprises a reflective low emissivity panel 11. The reflective low emissivity panel 11 permits visible light to pass through. In winter months, radiant heat originating from indoors is reflected back toward the interior of a building by the reflective low emissivity panel 11. Conversely, in summer months, infrared heat radiation from the sun is reflected away from the interior of the building by the reflective low emissivity panel 11.

The window frame 1 is hermetically connected around the first glazing panel 2 in order to enclose and provide structural support to the first glazing panel 2. The second glazing panel 3 is hermetically connected to the window frame 1. The second glazing panel 3 is pressed against the window frame and held in place via the at least one spacer 4, the at least one riser 5, and the at least one backing spacer 6 in order to form a hermetic seal. Additionally, the first glazing panel 2 and the second glazing panel 3 are offset from each other. The gap formed by offsetting the first glazing panel 2 and the second glazing panel 3 allows for the formation of the trapped air space 7 between the first glazing panel 2 and the second glazing panel 3. The trapped air space 7 is hermetically sealed in between the first glazing panel 2, the second glazing panel 3, and the window frame 1. Hermetically sealing the trapped air space 7 in between the first glazing panel 2, the second glazing panel 3, and the window frame 1 prevents air infiltration through the existing window unit and the present invention.

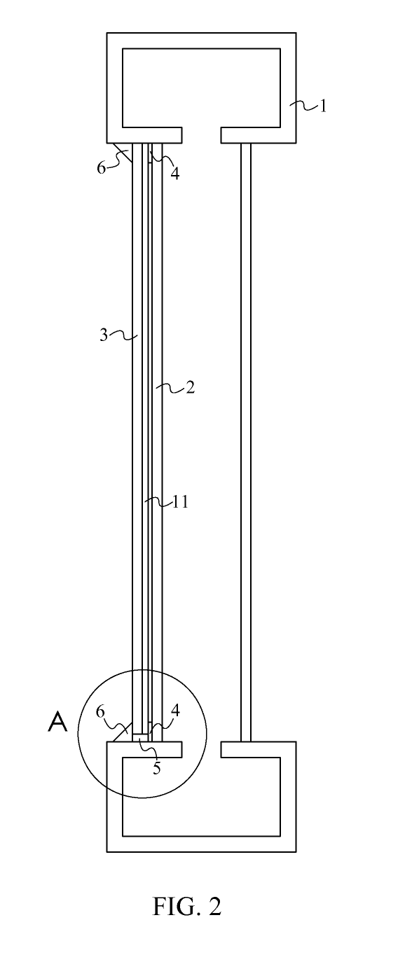

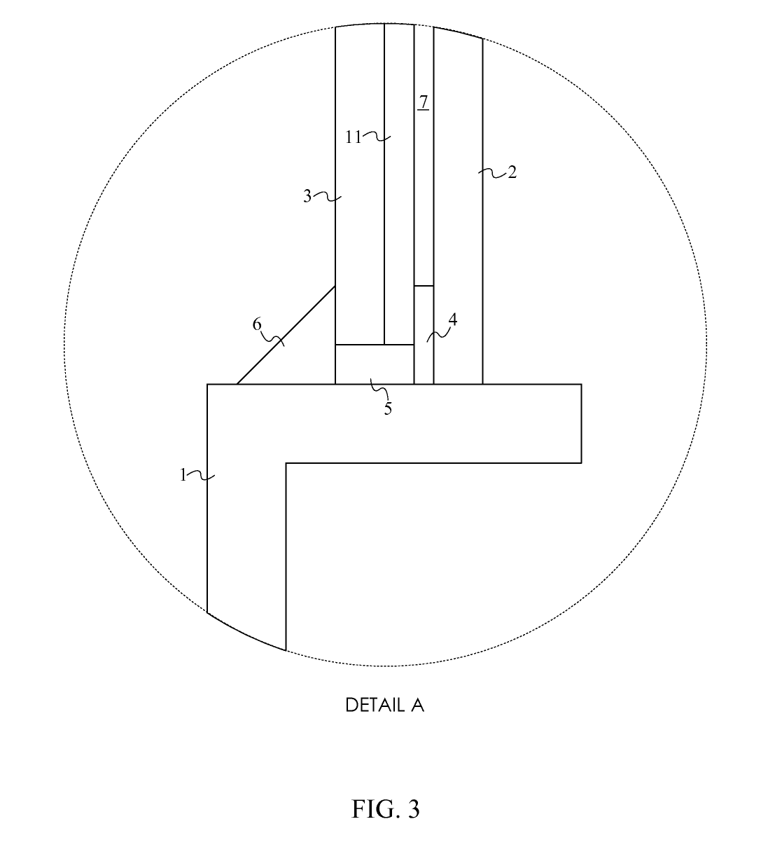

As shown in FIGS. 2-4, in the preferred embodiment of the present invention, the at least one spacer 4, the at least one riser 5, and the at least one backing spacer 6 are adhesively attached to the window frame 1, the first glazing panel 2, and the second glazing panel 3. The at least one spacer 4 is pressed against the second glazing panel 3 in between the first glazing panel 2 and the second glazing panel 3. This ensures that the second glazing panel 3 is offset from the first glazing panel 2 by the at least one spacer 4 and additionally ensures that a hermetic seal is formed between the window frame 1, the first glazing panel 2, and the second glazing panel 3. The at least one backing spacer 6 is pressed against the second glazing panel 3, opposite to the at least one spacer 4. The at least one backing spacer 6 is thus able to hold the second glazing panel 3 in place against the at least one spacer 4. The at least one spacer 4 and the at least one backing spacer 6 are overhung from the second glazing panel 3. This allows the second glazing panel 3 to rest on top of the at least one riser 5 as shown in FIG. 2 and FIG. 3. The at least one riser 5 is positioned in between the at least one spacer 4 and the at least one backing spacer 6, adjacent to the second glazing panel 3. This prevents the second glazing panel 3 from coming into contact with the window frame 1 when resting on top of the at least one riser 5.

In the preferred embodiment of the present invention, the reflective low emissivity panel 11 is superimposed upon the second glazing panel 3, opposite to the at least one backing spacer 6. This ensures that the entire surface area of the second glazing panel 3 is covered by the reflective low emissivity panel 11. The reflective low emissivity panel 11 is positioned adjacent to the at least one spacer 4 and the at least one riser 5 as well in order to maintain the hermetic seal.

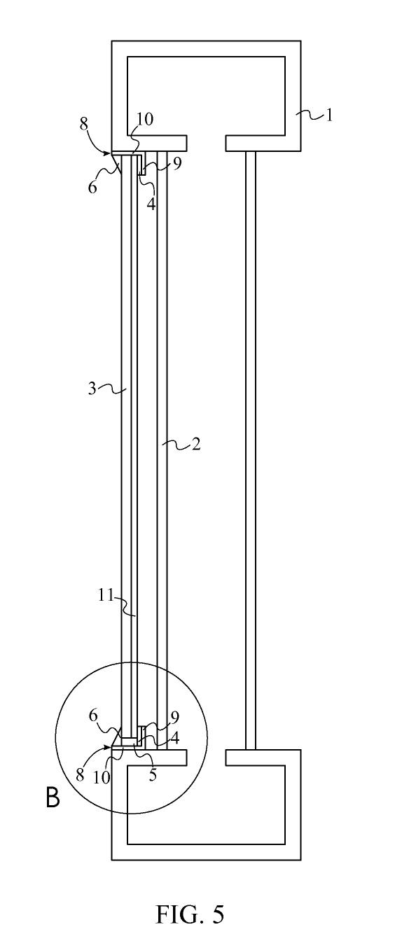

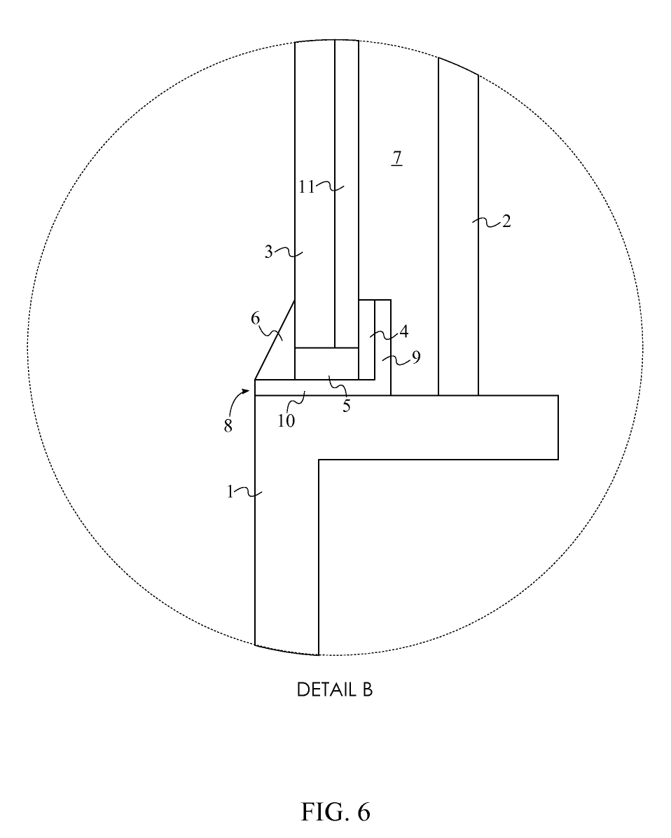

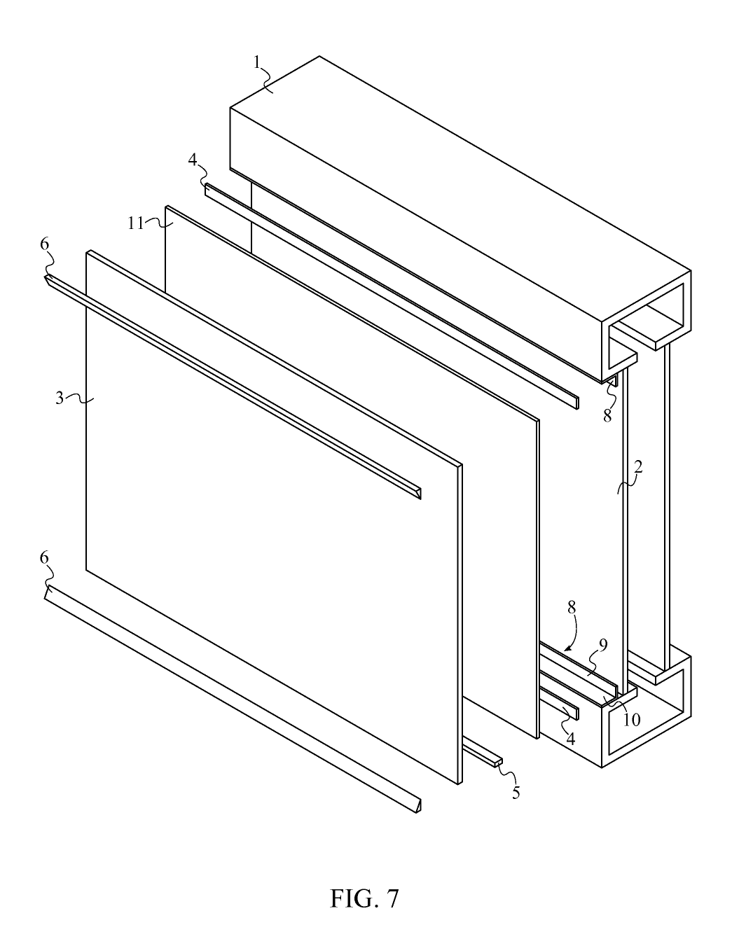

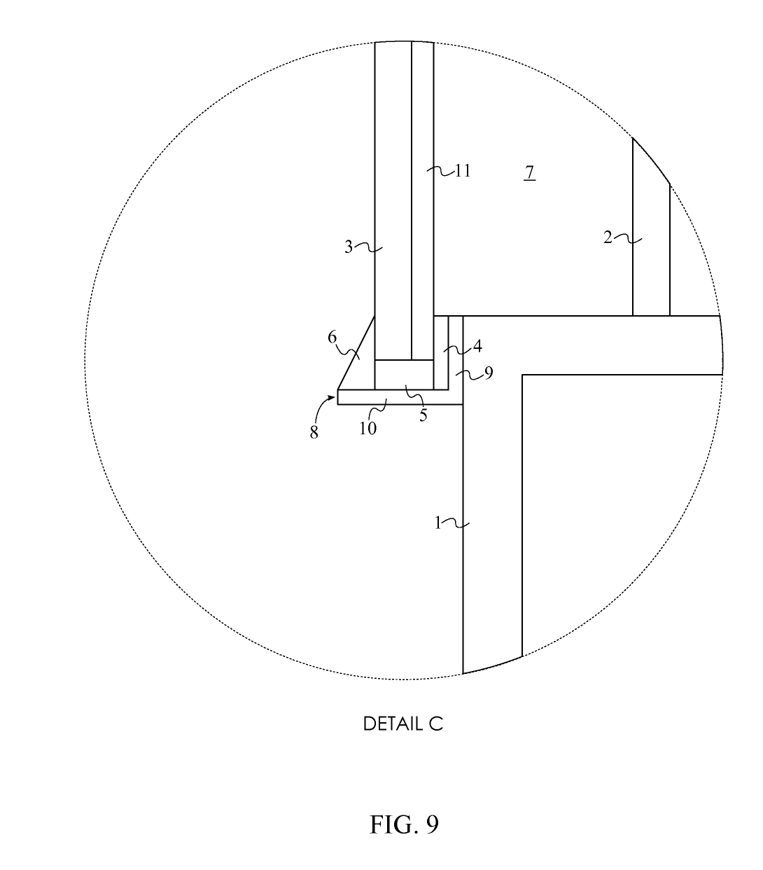

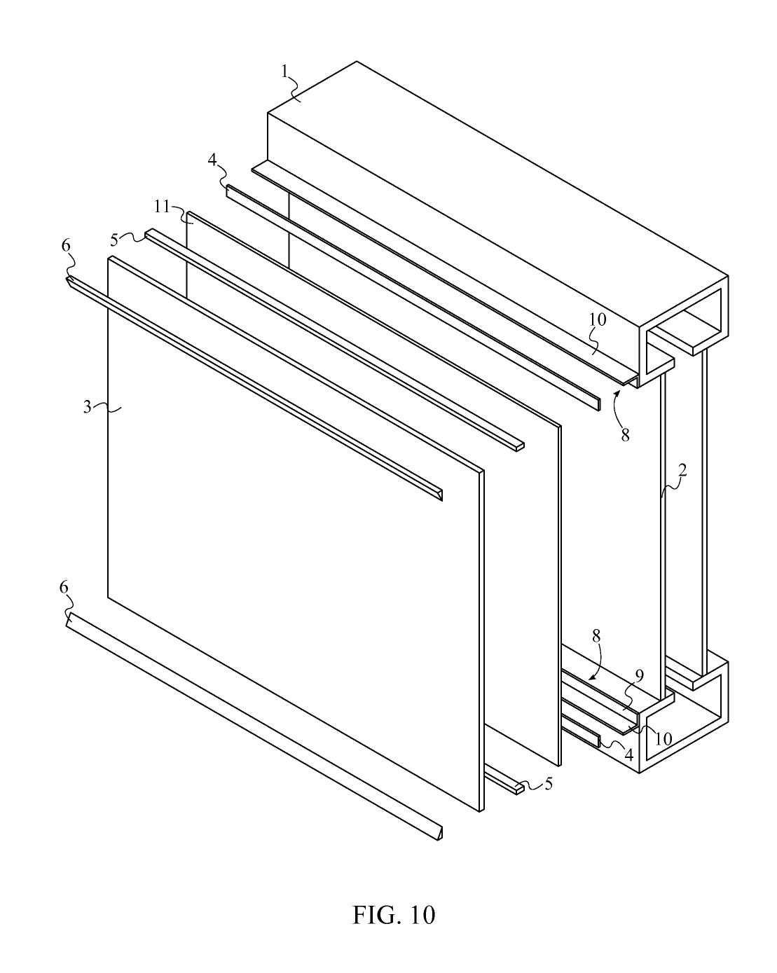

With reference to FIGS. 5-10, the present invention further comprises an at least one L-shaped bracket 8. The at least one L-shaped bracket 8 is utilized to adjust the positioning of the second glazing panel 3 as well as to adjust the size of the trapped air space 7 in between the first glazing panel 2 and the second glazing panel 3. The width of the trapped air space 7 may be set by the user in order to meet individual performance needs. The at least one L-shaped bracket 8 comprises a backing leg 9 and a base leg 10. The at least one L-shaped bracket 8 is connected across the window frame 1, allowing the second glazing panel 3 to be secured to the at least one L-shaped bracket 8, offset from the first glazing panel 2. The base leg 10 is the portion of the at least one L-shaped bracket 8 that is attached to the window frame 1. The backing leg 9 is the portion of the at least one L-shaped bracket 8 that holds the second glazing panel 3 in place. The backing leg 9 is oriented perpendicular to the base leg 10 in order to allow the second glazing panel 3 to be mounted to the at least one L-shaped bracket 8 after the at least one L-shaped bracket 8 has been mounted to the window frame 1. The backing leg 9 is pressed against the at least one spacer 4, opposite to the second glazing panel 3. This ensures that the second glazing panel 3 is held in place against the backing leg 9. The base leg 10 is pressed against the at least one riser 5, opposite to the second glazing panel 3. Thus, the second glazing panel 3 is able to rest on top of the at least one riser 5 with the at least one riser 5 resting on top of the base leg 10.

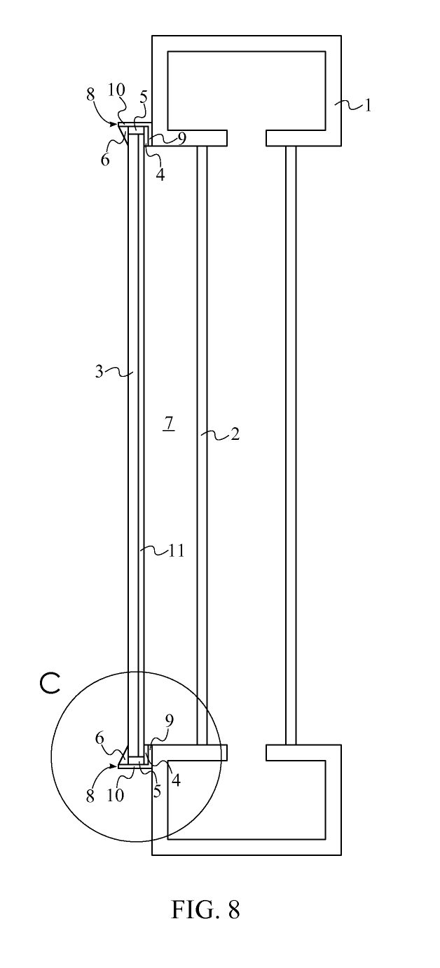

In the first alternative embodiment of the present invention shown in FIGS. 5-7, the base leg 10 is internally connected along the window frame 1. This allows the trapped air space 7 to be wider as the at least one L-shaped bracket 8 is offset from the first glazing panel 2. The second glazing panel 3 and the reflective low emissivity panel 11 are thus offset at a greater distance from the first glazing panel 2. The reflective low emissivity panel 11 is positioned adjacent to the at least one spacer 4 and the at least one riser 5 in order to maintain the hermetic seal when the at least one L-shaped bracket 8 is internally connected along the window frame 1. Conversely, in the second alternative embodiment of the present invention shown in FIGS. 8-10, the backing leg 9 is externally connected along the window frame 1. In this embodiment, the trapped air space 7 is wider even still as the distance from which the at least one L-shaped bracket 8 is offset from the first glazing panel 2 is greater as well. As such, the second glazing panel 3 and the reflective low emissivity panel 11 are offset at an even greater distance from the first glazing panel 2 than in the first alternative embodiment of the present invention. The reflective low emissivity panel 11 is positioned adjacent to the at least one spacer 4 and the at least one riser 5 in order to maintain the hermetic seal when the at least one L-shaped bracket 8 is externally connected along the window frame 1. The perpendicular orientation of the backing leg 9 and the base leg 10 allows the at least one L-shaped bracket 8 to be mounted onto a horizontal surface or a vertical surface as shown in the first alternative embodiment and the second alternative embodiment of the present invention.

Although the present invention has been explained in relation to its preferred embodiment, it is understood that many other possible modifications and variations can be made without departing from the spirit and scope of the present invention as hereinafter claimed.

What is claimed is:

1. A thermal break glazing insulation and infiltration reduction system comprises:
a window frame;
a first glazing panel;
a second glazing panel;
an at least one spacer;
an at least one riser;
an at least one backing spacer;
a trapped air space;
the window frame being hermetically connected around the first glazing panel;
the second glazing panel being hermetically connected to the window frame;
the first glazing panel and the second glazing panel being offset from each other;
the at least one spacer being pressed against the second glazing panel in between the first glazing panel and the second glazing panel;
the at least one backing spacer being pressed against the second glazing panel, opposite to the at least one spacer;
the at least one spacer and the at least one backing spacer being overhung from the second glazing panel;
the at least one riser being positioned in between the at least one spacer and the at least one backing spacer, adjacent to the second glazing panel; and
the trapped air space being hermetically sealed in between the first glazing panel, the second glazing panel, and the window frame.

2. The thermal break glazing insulation and infiltration reduction system as claimed in claim 1 further comprises:
an at least one L-shaped bracket;
the at least one L-shaped bracket comprises a backing leg and a base leg;
the at least one L-shaped bracket being connected across the window frame;
the backing leg being oriented perpendicular to the base leg;
the backing leg being pressed against the at least one spacer, opposite to the second glazing panel; and
the base leg being pressed against the at least one riser, opposite to the second glazing panel.

3. The thermal break glazing insulation and infiltration reduction system as claimed in claim 3 further comprises:
the base leg being internally connected along the window frame.

4. The thermal break glazing insulation and infiltration reduction system as claimed in claim 3 further comprises:
the backing leg being externally connected along the window frame.

5. The thermal break glazing insulation and infiltration reduction system as claimed in claim 1 further comprises:
a reflective low emissivity panel; and
the reflective low emissivity panel being superimposed upon the second glazing panel, opposite to the at least one backing spacer.

6. A thermal break glazing insulation and infiltration reduction system comprises:
a window frame;
a first glazing panel;
a second glazing panel;
an at least one spacer;
an at least one riser;
an at least one backing spacer;
a trapped air space;
a reflective low emissivity panel;
the window frame being hermetically connected around the first glazing panel;
the second glazing panel being hermetically connected to the window frame;
the first glazing panel and the second glazing panel being offset from each other;
the at least one spacer being pressed against the second glazing panel in between the first glazing panel and the second glazing panel;
the at least one backing spacer being pressed against the second glazing panel, opposite to the at least one spacer;
the at least one spacer and the at least one backing spacer being overhung from the second glazing panel;
the at least one riser being positioned in between the at least one spacer and the at least one backing spacer, adjacent to the second glazing panel;
the trapped air space being hermetically sealed in between the first glazing panel, the second glazing panel, and the window frame; and
the reflective low emissivity panel being superimposed upon the second glazing panel, opposite to the at least one backing spacer.

7. The thermal break glazing insulation and infiltration reduction system as claimed in claim 6 further comprises:
an at least one L-shaped bracket;
the at least one L-shaped bracket comprises a backing leg and a base leg;
the at least one L-shaped bracket being connected across the window frame;
the backing leg being oriented perpendicular to the base leg;
the backing leg being pressed against the at least one spacer, opposite to the second glazing panel; and
the base leg being pressed against the at least one riser, opposite to the second glazing panel.

8. The thermal break glazing insulation and infiltration reduction system as claimed in claim 7 further comprises:
the base leg being internally connected along the window frame.

9. The thermal break glazing insulation and infiltration reduction system as claimed in claim 7 further comprises:
the backing leg being externally connected along the window frame.

10. A thermal break glazing insulation and infiltration reduction system comprises:
a window frame;
a first glazing panel;
a second glazing panel;
an at least one spacer;
an at least one riser;
an at least one backing spacer;
a trapped air space;
a reflective low emissivity panel;
an at least one L-shaped bracket;
the at least one L-shaped bracket comprises a backing leg and a base leg;
the window frame being hermetically connected around the first glazing panel;
the second glazing panel being hermetically connected to the window frame;
the first glazing panel and the second glazing panel being offset from each other;
the at least one spacer being pressed against the second glazing panel in between the first glazing panel and the second glazing panel;
the at least one backing spacer being pressed against the second glazing panel, opposite to the at least one spacer;
the at least one spacer and the at least one backing spacer being overhung from the second glazing panel;
the at least one riser being positioned in between the at least one spacer and the at least one backing spacer, adjacent to the second glazing panel;
the trapped air space being hermetically sealed in between the first glazing panel, the second glazing panel, and the window frame;
the reflective low emissivity panel being superimposed upon the second glazing panel, opposite to the at least one backing spacer;
the at least one L-shaped bracket being connected across the window frame;
the backing leg being oriented perpendicular to the base leg;
the backing leg being pressed against the at least one spacer, opposite to the second glazing panel; and
the base leg being pressed against the at least one riser, opposite to the second glazing panel.

11. The thermal break glazing insulation and infiltration reduction system as claimed in claim 10 further comprises:
the base leg being internally connected along the window frame.

12. The thermal break glazing insulation and infiltration reduction system as claimed in claim 10 further comprises:
the backing leg being externally connected along the window frame.
